(19) United States
(12) Patent Application Publication
(10) Pub. No.: US 2007/0299185 A1
(43) Pub. Date: Dec. 27, 2007

(54) Method for forming nanocomposites

(76) Inventors: Robert A. Ottaviani, Anthem, AZ (US); William R. Rodgers, Bloomfield Township, MI (US); Paula D. Fasulo, Eastpointe, MI (US); Tadeusz B. Pietrzyk, Sterling Heights, MI (US); Charles K. Buehler, Warren, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/177,841

(22) Filed: Jul. 8, 2005

(51) Int. Cl. C08K 9/04

(52) U.S. Cl. 524/445

(57) ABSTRACT

A method of forming a nanocomposite material includes polymerizing a first monomer to form a first polymeric material. A second monomer is added to the first polymeric material and the second monomer is also polymerized to form a polymeric mixture of the first and second polymers, or a polymeric reactor material. The polymeric reactor material is compounded with a concentrate that includes a nanofiller material mixed in a wetting material, thereby forming the nanocomposite material.

### TECHNICAL FIELD

The present disclosure relates generally to nanocomposites, and more particularly to the formation of nanocomposite materials.

### BACKGROUND

Nanotechnology can be defined as materials or devices engineered at the molecular level. Within this category are polymer nanocomposites, which are a class of materials that use molecular sized particles for reinforcing the polymer matrix, e.g. the reinforcing filler possesses one or more dimensions on a sub-micrometer scale. These materials blend a nanofiller with a polymer to produce a composite with equal or better physical and mechanical properties than their conventionally filled counterparts but at lower filler loadings.

Due to the surface area available with nanofillers, polymer nanocomposites offer the potential for enhanced mechanical properties, barrier properties, thermal properties, and flame retardant properties when compared to conventionally filled materials.

One class of polymer nanocomposites uses a filler material that is based on the smectite class of aluminum silicate clays, a common representative of which is montmorillonite.

Current processes for forming nanocomposites generally include individual steps for polymerizing each of the various monomers and for separately pelletizing each of the various formed polymers. After the individual polymers are pelletized, the formed pellets may be mixed with a nanofiller material in an extruder to form the nanocomposite material. While this process may, in some instances, be efficient for forming nanocomposites, it also may, at times, be time consuming and relatively expensive.

### SUMMARY

Embodiments of the method of forming a nanocomposite material substantially solve the drawbacks enumerated above. An embodiment of the method includes polymerizing a first monomer to form a first polymeric material. A second monomer is added to the first polymeric material, and the second monomer is also polymerized to form a polymeric mixture of the first and second polymers, or a polymeric reactor material. The polymeric mixture is compounded with a concentrate, thereby forming the nanocomposite material. The concentrate includes, but is not limited to, a nanofiller material mixed with a wetting material.

### BRIEF DESCRIPTION OF THE DRAWING

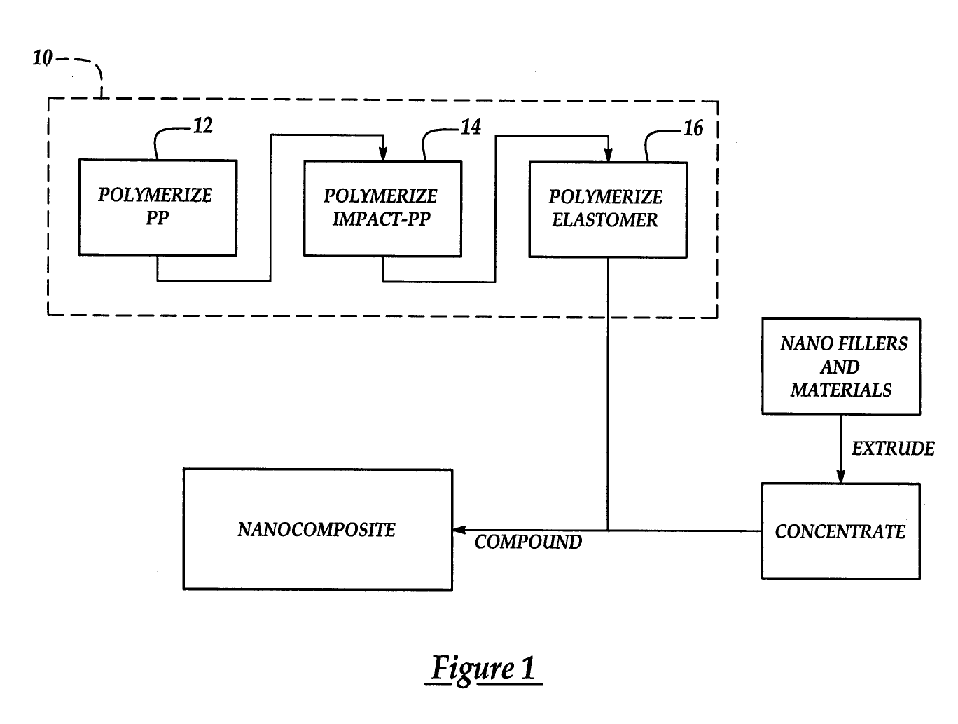

Objects, features, and advantages of embodiments of the present disclosure may become apparent upon reference to the following detailed description and drawing, in which FIG. 1 is a schematic process flow diagram of an embodiment of the method of the present disclosure.

### DETAILED DESCRIPTION OF THE EMBODIMENTS

The present disclosure is predicated upon the unexpected and fortuitous discovery that by using an in-line processing method, a nanocomposite material having the required and/or desired properties may be formed substantially quickly and efficiently. An embodiment of the method includes polymerizing a first monomer in a gas phase to form a first polymeric material. A second monomer is added to the first polymeric material and the second monomer is also polymerized in a gas phase to form a polymeric reactor material. The polymeric reactor material may be compounded with a concentrate, thereby forming the nanocomposite material. The concentrate includes a nanofiller material mixed with a wetting material. An alternate embodiment of the method includes adding and polymerizing additional monomers (e.g. a third monomer) to the polymeric mixture of the first and second polymers to form a polymeric mixture (i.e. polymeric reactor material) of the first, second, and any additional polymers.

Referring now to FIG. 1, a schematic process flow diagram illustrates an embodiment of the method. In an embodiment of the method, one or more monomer(s) may be polymerized in a reactor 10 (shown in phantom). It is to be understood that any suitable monomer(s) may be used. In an embodiment, the monomers include, but are not limited to propylene, ethylene, 1-butene, 1-hexene, 1-octene, and/or mixtures thereof.

It is to be understood that the polymerization of the monomer(s) occurs using an in-line processing method. For example, box 12 represents a first monomer (e.g. propylene) being polymerized in the gas phase in the reactor 10 to form a first polymeric material (e.g. polypropylene). Box 14 represents the addition of a second monomer and an additional initiator into the still polymerizing first polymeric material. In an embodiment of the method, the second monomer is polymerized in the gas phase to form a polymeric mixture of the first and second polymers. Box 16 in FIG. 1 illustrates an embodiment of the method wherein a third monomer, and still more initiator, is added to the polymeric mixture of the first and second polymers. The third monomer is also polymerized in the gas phase to form a polymeric mixture of the first, second, and third polymers. It is to be understood that any number of monomers may be added to the reactor to form the final polymeric mixture. It is to be further understood that polymerization may occur in solution, however, this process may involve the removal of solvent from the final product prior to collection of the solid resin.

Non-limitative examples of the polymeric materials that are formed in the reactor 10 generally include polypropylenes, polyethylenes, elastomers, polyolefins, impact copolymers thereof, and/or mixtures thereof.

As shown in FIG. 1, polypropylene (PP), impact polypropylene, and elastomers are formed in the reactor 10. In an alternate embodiment, the formed polymeric mixture may include, but is not limited to a thermoplastic olefinic resin including at least one of polypropylene homopolymers, impact modified polypropylenes, ethylene-propylene based elastomers, and/or mixtures thereof.

Embodiment(s) of the method further include preparing a concentrate. It is to be understood that the concentrate may be prepared outside of the reactor 10 wherein the monomers are polymerized. Without being bound to any theory, it is also believed that the concentrate may be prepared inside the reactor 10. In such an embodiment, the nanofiller material may be used as a catalyst support and may be included in the final material.

In an embodiment, the concentrate includes a nanofiller material mixed in a wetting material, either with or without additional polymeric resins. The materials may be substantially homogeneously or non-homogeneously mixed and then extruded to form the concentrate.

Non-limitative examples of the wetting material include compatibilizers based on acrylic acid or maleic anhydride substitution on a polymer backbone, or any other polymer with attached groups that may lead to substantial polar interactions with the nanofiller material.

It is to be understood that the nanofiller material may be any suitable nanofiller material. In an embodiment, the nanofiller material is a clay material. Examples of suitable clay materials include, but are not limited to at least one of smectite, hectorite, montmorillonite, bentonite, beidelite, saponite, stevensite, sauconite, nontronite, illite, and/or mixtures thereof. It is to be understood that the clay material may be an organically modified clay material, e.g. an organoclay. In an embodiment, the nanofiller material is an aluminum silicate smectite clay. In a further embodiment, the nanofiller is organically modified montmorillonite.

In an embodiment, the concentrate has a ratio of nanofiller material to wetting material ranging between about 20:80 and about 80:20. In other embodiments, the concentrate has a ratio of nanofiller material to wetting material ranging from about 40:60 to about 70:30, or ranging from about 50:50 to about 70:30.

It is to be understood that the concentrate may be prepared before compounding the polymeric reactor material with the concentrate. It is also to be understood that the concentrate may further optionally include an antioxidant.

Embodiment(s) of the method further includes compounding the concentrate and the polymeric reactor material to form the nanocomposite material. It is to be understood that compounding occurs outside of the reactor 10 in which the polymeric materials are formed.

Compounding may be accomplished via any suitable process to incorporate the nanofiller material into the polymeric mixture. Such processes may include, but are not limited to, processes using co-rotating twin screw extruders, counter-rotating twin screw extruders, oscillating single screw extruders (non-limitative examples of which include those available under the tradename BUSS® kneaders), conical twin screw extruders, internal mixers (non-limitative examples of which include those that are available under the tradenames BANBURY® mixers and BRABENDER® mixers), or any suitable equipment by which polymers may be melt processed.

In an embodiment of the nanocomposite material, the concentrate material may be present in an amount ranging between about 2.5 wt. % and about 60 wt. %, and the polymeric mixture (one example of which is a reactor flake) may be present in an amount ranging between about 97.5 wt. % and about 40 wt. %. The final nanocomposite material also exhibits enhanced physical properties, including, but not limited to, improved tensile and flexural modulus, with the retention of ductile impact.

In an alternate embodiment, the method for forming a nanocomposite material includes compounding a polymeric mixture with the concentrate including a mixture of the nanofiller material and the wetting material, thereby forming the nanocomposite material.

To further illustrate embodiment(s) of the present disclosure, the following example is given. It is to be understood that this example is provided for illustrative purposes and is not to be construed as limiting the scope of embodiment(s) of the present disclosure.

### EXAMPLE

In this example, commercially available polymers were mixed together to form the polymeric mixture. The nanofiller material was added to an amount of a wetting material to form a concentrate. The polymeric mixture was then compounded with the concentrate to form the nanocomposite materials. The nanocomposite materials were evaluated. The formulations of the various nanocomposites are shown in Table II.

Non-limitative examples of suitable polymeric materials are shown in Table I under the labels “Polypropylenes,” “Propylene Copolymers” and “Elastomers.” Non-limitative examples of suitable compatibilizing materials are shown in Table I under the label “Compatibilizing Resins.” Non-limitative examples of suitable optional additives are shown in Table I under the label “Antioxidants/Light Stabilizers.”

TABLE I

| MATERIAL | SUPPLIER | GRADE |
|---|---|---|
| Polypropylenes | Basell USA, Inc.; | PROFAX 6301, PROFAX 6323, PROFAX 6523, |
| | Lansing, Michigan | PROFAX PD 702, PROFAX PH020, PROFAX PH 382M |
| | Dow Chemical; | TF-1802 |
| | Midland, Michigan | |
| | Equistar Chemicals LP; | PETROTHENE PP 8001-LK, PETROTHENE PP 8020-AU, |
| | Houston, Texas | PETROTHENE PP8020-GU |
| | ExxonMobil Chemical; | PP-1074KN, PP1105E1, PP-3546G, PP1044 |
| | Houston, Texas | |
| | Huntsman Polymers LLC; | H0500NS, P4CCN-41 |
| | Marysville, Michigan | |
| Propylene Copolymers | Basell USA, Inc.; | PROFAX 7101S, METOCENE RM 1099, Profax EL245S, |
| | Lansing, Michigan | PROFAX SD-242, PROFAX SG-702, Profax SV-152, |
| | | HIFAX CA53G |
| | Dow Chemical; | C700-35N, C702-20, 705-44 NA |
| | Midland, Michigan | |
| | Equistar Chemicals LP; | PETROTHENE PP36KK01, PETROTHENE PP35FR03, |
| | Houston, Texas | PETROTHENE PP35FU01, PETROTHENE PP44FY01, |
| | | PETROTHENE PP44FZ01, PETROTHENE PP8752HF, |
| | | PETROTHENE PP8462HR, PETROTHENE PP8775HU |
| | ExxonMobil Chemical; | PP-AX03BE5, PP822XE1, MYTEX AN17K-01, |
| | Houston, Texas | PP7032KN, PP7033N, PP8023 |
| Elastomers | Basell USA, Inc.; | ADFLEX KS021P, ADFLEX KS357P, HIFAX CA207A, |
| | Lansing, Michigan | HIFAX CA10GC, HIFAX CA244 |
| | Dupont-Dow Elastomers LLC; | ENGAGE 8100, ENGAGE 8150, ENGAGE 8200, |
| | Wilmington, Delaware | ENGAGE 8440, ENGAGE 8540, ENGAGE 8842, |
| | | NORDEL IP NDR3722P, NORDEL IP NDR4820P, |
| | | NORDEL IP NDR3670, NORDEL IP NDR4725P, |
| | | NORDEL IP NDR4770R |
| | Equistar Chemicals LP; | PETROTHENE PP8312-KO, PETROTHENE PP43QW02 |
| | Houston, Texas | |
| | ExxonMobil Chemical; | EXACT 0201, EXACT 0210, EXACT 8201, |
| | Houston, Texas | EXACT 8210, EXACT 4053, EXACT 4041, |
| | | EXACT 3035, VISTALON 404, VISTALON 707, |
| | | VISTALON 785 |
| Compatibilizing Resins | Eastman Chemical Co.; | EPOLENE E-43, EPOLENE G-3003, EPOLENE G-3015, |
| | Carpentersville, Illinois | EPOLENE C-16, EPOLENE C-18, |
| | Crompton Chemicals; | POLYBOND 1001, POLYBOND 1002, POLYBOND 1009, |
| | Taft, Louisiana | POLYBOND 3000, POLYBOND 3002, POLYBOND 3009, |
| | | POLYBOND 3150, POLYBOND 3200 |
| | ExxonMobil Chemical; | EXXELOR PO1015, EXXELOR PO1020, EXXELOR VA1840 |
| | Houston, Texas | |
| Antioxidants/Light Stabilizers | Ciba Specialty Chemicals; | IRGAFOS 126, IRGAFOS 168, IRGANOX 1010, |
| | Tarrytown, New York | IRGANOX 1076, IRGANOX B900, IRGASTAB FS 210, |
| | | IRGASTAB FS 301, IRGASTAB FS 811, IRGASTAB FS 812 |
| | Cytec Industries Inc.; | CYASORB UV531, CYASORB UV1164, CYASORB UV3346, |
| | Kalamazoo, Michigan | CYASORB THT4611, CYANOX 1212, CYANOX 2246 |
| | Great Lakes Polymer Additives; | ALKANOX 240, ALKANOX 240-3T, ANOX 70, LOWINOX CPL |
| | West Lafayette, Indiana | |

The formulations made and tested are shown in Table II under “Formulations 1-5.”

TABLE II
Formulations (in weight %)

| | 1 | 2 | 3 | 4 | 5 |
|---|---|---|---|---|---|
| Materials | | | | | |
| Thermoplastic Olefin | 99.8 | 96.9 | 95 | 92.4 | 83.2 |
| Resin | | | | | |
| Standard Clay | | 2.9 | 4.8 | | |
| Concentrate | | | | 7.4 | 16.6 |
| (25:75 Standard | | | | | |
| Clay:Compatibilizing | | | | | |
| Resin) | | | | | |
| Antioxidant | 0.2 | 0.2 | 0.2 | 0.2 | 0.2 |
| Operating Parameters | | | | | |
| Max. Melt Temp. | 163 | 167 | 163 | 161 | 167 |
| (° C.) | | | | | |
| Extruder RPM | 300 | 300 | 300 | 300 | 300 |
| Energy Input (KJ/g) | 1.71 | 1.87 | 1.78 | 1.79 | 1.72 |

As shown in Table II, formulations 4 and 5 contain the concentrate (standard clay in maleated resin compatibilizer). One non-limitative example of a standard clay is CLOISITE 15A (a sodium montmorillonite clay treated with dimethyl, dihydrogenated tallow quaternary ammonium chloride). CLOISITE 15A is commercially available from Southern Clay Products, Inc. in Gonzales, Tex.

These formulations were compared with formulations having standard clay added (2 and 3) without a wetting material to wet the clay and a formulation with nothing added (1), the control. The operating parameters are also shown in Table II. The maximum melt temperature was kept for all formulations within a range of about 161° C. to about 167° C. The extruder was run at a constant of 300 RPM for all formulations. Lastly, the energy imparted to the extruder for all formulations was about 540 KJ/min. Depending on the torque, the energy input varied slightly for each formulation, but was within a range of about 1.71 KJ/g to about 1.87 KJ/g for all formulations.

The properties of the various formulations are given in Table III.

TABLE III

| | 1 | 2 | 3 | 4 | 5 |
|---|---|---|---|---|---|
| Properties | | | | | |
| Specific Gravity | 0.89 | 0.90 | 0.91 | 0.90 | 0.91 |
| Melt Flow Rate (MFR) (g/10 min) | 16.2 | 12.7 | 15.9 | 20.3 | 18.1 |
| Melt Volume Flow Rate (cc/10 r) | 18.2 | 14.1 | 17.5 | 22.6 | 19.9 |
| Inorganic Content (%) | .01 | 1.91 | 2.56 | 1.05 | 2.31 |
| Tensile ISO (2 mm/min) | | | | | |
| Tensile at Max (psi) | 2625 | 2562 | 2800 | 2937 | 3012 |
| Tensile at Yield (psi) | 2446 | 2241 | 2766 | 2930 | 3000 |
| Tensile at Break (psi) | 2364 | 2421 | 2412 | 2311 | 2185 |
| Elongation at Yield (%) | 13.0 | 15 | 13 | 14 | 13 |
| Elongation at Break (%) | 570 | 580 | 550 | 700 | 180 |
| Flex Modulus (kpsi) 2 mm/min | 102 | 110 | 144 | 149 | 169 |
| % increase over unfilled | — | 7.8 | 41.2 | 46.1 | 65.7 |
| Increase per % inorganic | — | 4.2 | 16.4 | 44.8 | 29.0 |
| Tool Shrink | 7.47 | 5.15 | 8.14 | 7.75 | 6.66 |
| Afterbake (121° C., 1 hr) | 10.2 | 8.02 | 11.1 | 10.7 | 9.45 |
| Dynatup at −30° C., 5 mph | | | | | |
| Total Energy | 40.3 | 40.5 | 46.5 | 45.7 | 45.3 |
| Energy at Max Load | 24.1 | 22.6 | 26.7 | 27 | 27.4 |
| Deflection at Max Load (mm) | 25 | 28.3 | 27.6 | 25.4 | 23.6 |
| Total Deflection (mm) | 14.6 | 14.7 | 14.5 | 14.3 | 14.3 |
| Ductile/Brittle Failure | 5D | 5D | 5D | 5D | 5D |
| Ductility Index | 40.2 | 44.2 | 42.6 | 40.9 | 39.5 |
| Heat Distortion Temp. (HDT) at 264 psi (° C.) | 39.9 | 39.9 | 42.2 | 42 | 42.4 |
| HDT at 66 psi (° C.) | 62.1 | 61.2 | 65.7 | 69.2 | 67.3 |
| Coefficients of Linear Thermal Expansion | 8.1 | 6 | 7 | 6.7 | 6.2 |
| (CLTE) (×10 − 5) (−30° C.˜100° C.) | | | | | |

In the first formulation (1), the control (having no concentrate) had a flex modulus of 102 Kpsi at 2 mm/min. The second (2) and third (3) formulations containing the standard clay without a wetting material, yielded flex moduli of 110 and 144 Kpsi, respectively. For the second (2) formulation, this corresponded to a 7.8 percentage increase over the unfilled control formulation (1) and a 4.2 percentage increase per percentage of inorganic. In the third (3) formulation, the flex modulus corresponded to a 41.2 percentage increase over the unfilled control formulation (1) and a 16.4 percentage increase per percentage of inorganic. The fourth (4) and fifth (5) formulations, containing the concentrate including both standard clay and wetting material (compatibilizing resin), yielded flex moduli of 149 and 169 Kpsi, respectively. For the fourth (4) formulation, this corresponded to a 46.1 percentage increase over the unfilled control formulation (1) and a 44.8 percentage increase per percentage of inorganic. In the fifth (5) formulation, the flex modulus corresponded to a 65.7 percentage increase over the unfilled control formulation (1) and a 29.0 percentage increase per percentage of inorganic. Therefore, comparing formulation (2) with formulation (4), and comparing formulation (3) with formulation (5), it is demonstrated that when using embodiments of nanocomposites formed by embodiments of the present disclosure, a substantially higher flexural modulus is yielded when the concentrate of standard clay and wetting material is used.

The remaining properties, as shown in Table III, as observed and measured for formulations (4) and (5) (containing the concentrate) were consistent with the properties of a typical nanocomposite, as represented by the other formulations (1), (2), and (3). Therefore, it is demonstrated that the nanocomposite material yielded from using the in-line processing method according to embodiment(s) disclosed herein also has equal or better required and/or desired properties of typically formed nanocomposites.

While several embodiments of the disclosure have been described in detail, it will be apparent to those skilled in the art that the disclosed embodiments may be modified. Therefore, the foregoing description is to be considered exemplary rather than limiting.

1. A method of forming a nanocomposite material, the method comprising:
polymerizing a first monomer to form a first polymeric material;
adding a second monomer to the first polymeric material and polymerizing the second monomer, thereby forming a polymeric reactor material; and
compounding the polymeric reactor material with a concentrate including a mixture of a nanofiller material and a wetting material, thereby forming the nanocomposite material.

2. The method as defined in claim 1 wherein the wetting material is at least one of compatibilizers based on acrylic acid substitution on a polymer backbone, compatibilizers based on maleic anhydride substitution on a polymer backbone, polymers having groups attached thereto, the groups capable of substantial polar interaction with the nanofiller material, and combinations thereof.

3. The method as defined in claim 1 wherein at least one of the first and second monomers comprise at least one of ethylene, propylene, 1-butene, 1-hexane, 1-octane, and mixtures thereof.

4. The method as defined in claim 1 wherein at least one of the first and second polymeric materials comprise at least one of polypropylenes, polyethylenes, elastomers, polyolefins, impact copolymers thereof, and mixtures thereof.

5. The method as defined in claim 1 wherein the polymeric reactor material comprises thermoplastic olefins including at least one of polypropylene homopolymers, impact modified polypropylenes, ethylene-propylene based elastomers, and mixtures thereof.

6. The method as defined in claim 1 wherein each of the polymerizing steps is accomplished in a reactor.

7. The method as defined in claim 6 wherein the compounding occurs outside of the reactor.

8. The method as defined in claim 1 wherein the concentrate has a ratio of nanofiller material to wetting material ranging between about 20:80 and about 80:20.

9. The method as defined in claim 1 wherein the concentrate further comprises an antioxidant.

10. The method as defined in claim 1 wherein the nanofiller material comprises at least one of smectite, hectorite, montmorillonite, bentonite, beidelite, saponite, stevensite, sauconite, nontronite, illite, and mixtures thereof.

11. The method as defined in claim 1 wherein the concentrate material is present in the nanocomposite material an amount ranging between about 2.5 wt. % and about 60 wt. %, and the polymeric reactor material is present in an amount ranging between about 97.5 wt. % and about 40 wt. %.

12. The method as defined in claim 1, further comprising adding a third monomer to the polymeric mixture of the first polymeric material and the second polymeric material, and polymerizing the third monomer to form a polymeric mixture of the first polymeric material, the second polymeric material, and a third polymeric material, thereby forming the polymeric reactor material.

13. The method as defined in claim 1 wherein polymerizing is accomplished in a gas phase.

14. A nanocomposite material formed by the method as defined in claim 1.

15. The nanocomposite material as defined in claim 14 wherein the concentrate material is present in an amount ranging between about 2.5 wt. % and about 60 wt. %, and the polymeric reactor material is present in an amount ranging between about 97.5 wt. % and about 40 wt. %.

16. A method for forming a nanocomposite material, the method comprising:
polymerizing a first monomer in a gas phase in a reactor to form a first polymeric material;
adding a second monomer to the first polymeric material in the reactor and polymerizing the second monomer in a gas phase to form a polymeric mixture of the first polymeric material and a second polymeric material;
adding a third monomer to the polymeric mixture of the first polymeric material and the second polymeric material in the reactor and polymerizing the third monomer in a gas phase, thereby forming a polymeric reactor material;
preparing a concentrate having a nanofiller material mixed in a wetting material; and
compounding the polymeric reactor material with the concentrate, thereby forming the nanocomposite material.

17. The method as defined in claim 16 wherein the wetting material is at least one of compatibilizers based on acrylic acid substitution on a polymer backbone, compatibilizers based on maleic anhydride substitution on a polymer backbone, polymers having groups attached thereto, the groups capable of substantial polar interaction with the nanofiller material, and mixtures thereof.

18. The method as defined in claim 16 wherein the polymeric reactor material comprises at least one of polypropylene homopolymers, impact modified polypropylenes, ethylene-propylene based elastomers, and mixtures thereof.

19. The method as defined in claim 16 wherein the compounding occurs outside of the reactor.

20. The method as defined in claim 16 wherein the concentrate has a ratio of nanofiller material to wetting material ranging from about 20:80 and about 80:20.
